(19) United States
(12) Patent Application Publication
(10) Pub. No.: US 2010/0308589 A1
(43) Pub. Date: Dec. 9, 2010

(54) Heaving ocean wave energy converter

(75) Inventor: John W. Rohrer, York, ME (US)

Correspondence Address: John W. Rohrer;Rohrer Technologies, Inc., 5 Long Cove Rd., York, ME, 03909, US

(73) Assignee: Rohrer Technologies, Inc., York, ME (US)

(21) Appl. No.: 12/800,981

(22) Filed: May 27, 2010

Related U.S. Application Data
(63) Continuation-in-part of application No. 12/454,984, filed on May 27, 2009.

(51) Int. Cl. F03B 13/18

(52) U.S. Cl. 290/53

(57) ABSTRACT

An ocean wave energy device uses large gas filled and surface vented or evacuated flexible containers having rigid movable ends and rigid fixed depth ends connected by flexible bellows, suitably reinforced against external hydrostatic pressure, submerged to a depth below anticipated wave troughs. One or more containers compress and expand as waves and troughs, respectively, pass overhead driving hydraulic or pneumatic, pumping means producing pressurized fluid flow for a common sea bed motor-generator or for other uses or on-board direct drive generators. Mechanical, hydraulic or pneumatic means re-expand said containers when a wave trough is overhead. Power output is augmented by mechanically connecting said rigid moving surfaces to surface floats, which may also provide said surface vent such that as waves lift and troughs lower said floats, said containers are further compressed and re-expanded, respectively. Depth fixing and adjustment means for tides and sea-states are provided.

### FIELD OF INVENTION

This invention relates to devices for producing electrical power, pressurized water or other useful work from surface waves on a water body.

More particularly, this invention relates to wave energy converters wherein either all or a substantial portion of the energy captured or produced is from one or more submerged devices relying at least in part on overhead wave induced subsurface differences in hydrostatic pressure which expand and contract or otherwise deform or deflect one or more gas filled submerged containers thereby producing useful work.

### BACKGROUND OF THE INVENTION

Wave energy commercialization lags well behind wind energy despite the fact that water is several hundred times denser than air and waves remain for days and even weeks after the wind which originally produced them has subsided. Waves, therefore, efficiently store wind kinetic energy at much higher energy densities, typically averaging up to 50 to 100 kw/m of wave front in many northern latitudes.

Hundreds of uniquely different ocean wave energy converters (OWECs) have been proposed over the last century and are described in the patent and commercial literature. Inexpensive fossil fueled and hydroelectric power, however, has resulted in few commercial OWEC deployments. Less than a dozen OWEC designs are currently deployed as “commercial proto-types.” Virtually all of these suffer from high cost per average unit of energy capture. This is primarily due to the use of heavy steel construction necessary for severe sea-state survivability combined with (and in part causing) low wave energy capture efficiency. Only about 10% of currently proposed OWEC designs are deployed subsurface where severe sea-state problems are substantially reduced. Most subsurface OWECs are, unfortunately, designed for near shore sea bed deployment. Ocean waves lose a substantial portion of their energy as they approach shore (due to breaking, reflected waves, and bottom hydrodynamic friction effects). Near shore, submerged sea bed OWECs must be deployed at greater depths relative to average wave trough depths due to severe sea-state considerations to avoid breaking wave turbulence, and depth can not be adjusted for the large tidal depth variations found at the higher latitudes where average wave heights are greatest. Wave induced subsurface static pressure oscillations diminish more rapidly in shallow water as the depth below waves or swell troughs increases.

Only a few prior art subsurface devices use gas filled or evacuated containers like the present invention, producing container deformation in response to overhead wave or swell and trough induced hydrostatic pressure changes. None of these prior art subsurface OWECs enhance or supplement wave energy capture with overhead floating bodies like some embodiments of the present invention. All of the prior subsurface deformable container OWECs suffer from high moving mass (and therefore cost) and low energy capture efficiency often due to such high moving mass (even more cost) or due to near shore or sea bed deployment. None of these prior art submerged OWECs have the tidal and sea-state depth adjustability of the present invention needed for enhanced energy capture efficiency and severe sea state survivability. None have the low moving mass (allowing both short wave and long swell energy capture) and the large deformation stroke (relative to wave height) necessary for high capture efficiency of the present invention.

Several prior art devices use two variable volume gas filled containers, working in tandem, to drive a hydraulic turbine or motor. Gardner (U.S. Pat. No. 5,909,060) describes two sea bed deployed gas filled submerged inverted cup shaped open bottom containers laterally spaced from each other at the “expected” average wavelength. The inverted cups are rigidly attached to each other at the tops by a duct. The cups rise and fall as overhead waves create static pressure differences, alternately increasing and decreasing the gas volume and hence buoyancy in each. The rise of one container and concurrent fall of the other (called an “Archemedes Wave Swing”) is converted into hydraulic work by pumps driven by said swing.

Similarly, Van Den Berg (WO/1997/037123 and FIG. 1) uses two sea bed deployed submerged average wavelength spaced interconnected pistons, sealed to underlying gas filled cylinders by diaphragms. Submerged gas filled accumulators connected to each cylinder allow greater piston travel (with less gas compression resistance) and hence increased work. The reciprocating pistons respond to overhead wave induced hydrostatic pressure differences producing pressurized hydraulic fluid flow for hydraulic turbines or motors.

The twin vessel Archemedes Wave Swing (“AWS”) of Gardner (U.S. Pat. No. 5,909,060) later evolved into a single open bottomed vessel (FIG. 2) and then more recently Gardner's licensee, AWS Ocean Energy has disclosed a single enclosed gas filled vessel (an inverted rigid massive steel cup sliding over a second upright steel cup) under partial vacuum (FIG. 3). Partial vacuum, allowing increased stroke, is maintained via an undisclosed proprietary “flexible rolling membrane seal” between the two concentric rigid cups. Power is produced by a linear generator (FIG. 2 shown) or hydraulic pump driven by the rigid inverted moving upper cup. An elaborate external frame with rails and rollers, subject to fouling from ocean debris, is required to maintain concentricity between the cups and preserve the fragile membrane seal.

FIG. 4 (Burns U.S. 2008/0019847A1) shows a submerged sea bed mounted gas filled rigid cylindrical container with a rigid circular disc top connected by a small diaphragm seal. The disc top goes up and down in response to overhead wave induced static pressure changes and drives a hydraulic pump via stroke reducing, force increasing actuation levers. Burns recognized the stroke and efficiency limitations of using wave induced hydrostatic pressure variations to compress a gas and attempts to overcome this limitation by using multiple gas interconnected containers arranged perpendicular to oncoming wave fronts so one container expands as others compress (similar to Van Den Berg's accumulators). North (U.S. Pat. No. 6,700,217) describes a similar device. Both are sea bed and near shore mounted and neither is evacuated or surface vented like the present invention to increase stroke and, therefore, efficiency.

FIG. 5 (Meyerand U.S. Pat. No. 4,630,440) uses a constant volume of pressurized gas which expands and contracts a submerged unreinforced gas bladder housed within a fixed volume sea bed deployed rigid container in response to overhead wave induced static pressure changes. Bladder expansion and contraction within the container displaces sea water driving a hydraulic turbine as the sea water enters and exits the container. Expansion and contraction of the submerged bladder is enhanced via an above surface (shore mounted or floating) diaphragm or bellows. Unlike the present invention, very high gas pressure is required to reinflate the submerged sea bed bladder against the high hydrostatic pressure surrounding it.

### DISCLOSURE OF THE PRESENT INVENTION

According to embodiments of the present invention, one or more gas tight containers are submerged to a depth slightly below anticipated wave and swell troughs. The container(s) have a fixed depth rigid end or surface held at relatively fixed depth relative to the water body mean water level or average wave trough depth by either a flexible anchoring means, with horizontal depth stabilization discs or drag plates, or by a rigid sea bed attached spar or mast, or the bottom itself. A second movable rigid end or surface opposes said first fixed end or surface. Said fixed and movable ends are separated and connected by and sealed to a flexible, gas tight, reinforced elastomer or flexible metal bellows, or a diaphragm or accordion pleated skirt also suitably reinforced against collapse from container internal vacuum or external hydrostatic pressure. Overhead waves and troughs produce hydrostatic pressure variations which compress and expand said container, respectively, bringing said movable end closer to and further from said fixed depth end. This container expansion and contraction (or “stroke”) is enhanced by either partial evacuation of said container or venting of said container's gas to a floating surface atmospheric vent or to a floating surface expandable bellows, or reservoir. Without said partial evacuation or atmospheric venting, said stroke and hence energy capture would be reduced several fold by the compressive resistance of the enclosed gas. The relative linear motion between said container's fixed and movable ends is connected to and transferred to a hydraulic or pneumatic pumping means or, mechanical or electrical drive means. The pressurized fluid flow from said hydraulic or pneumatic pumping can drive a motor or turbine with electric generator. Mechanical means can direct drive a generator via rack and pinion gearing, oscillating helical drive or other oscillating linear one or two way rotational motion means. Electrical drive means can be by a linear generator. After compression return and expansion of said container and its' movable end can be assisted by mechanical (i.e. springs) pneumatic (compressed gas), hydraulic or electric means. Wave energy capture efficiency can be substantially enhanced by delaying said container compression and subsequent re-expansion until a wave or trough is directly overhead and hydrostatic pressure is maximized or minimized, respectively, by use of pressure sensors and hydraulic control valves. Power recovery can occur on either or both on strokes. The submerged depth of said container relative to the sea bed and wave troughs can be hydrostatically sensed and adjusted hydrostatically or by hydraulic or electro-mechanical drives for tides to maintain high efficiency by maintaining a relatively shallow submerged depth below wave troughs. The submerged depth can also be increased or the device can be temporarily locked down in its' compressed position during severe sea-states to increase survivability. The stroke or linear motion produced by said container's compression and expansion and applied to said pumping or drive means can be reduced and its' drive force correspondingly increased by use of leveraged connecting means such as rack and pinion or reduction gears, scissor-jacks, linear helical drivers, or lever and fulcrum actuators. High hydraulic pressure can be produced even in moderate sea states by the sequential use of multiple drive cylinders of different sectional areas or by using multi-stage telescoping cylinders. The linear oscillating motion of said container(s) expansion and contraction can be converted into smooth one way turbine, pump, motor or generator rotation via the use of known methods including high pressure hydraulic fluid accumulator tanks, flow check (one way) valves and circuits or mechanical drives, ratchets and flywheels. The subject device may have a typical diameter and stroke of 5-10 meters and produce 0.25 MW to 1 MW of electrical power. Elongated or multi-unit devices may have major dimensions and outputs of several times that.

### DISTINGUISHING FEATURES OVER PRIOR ART

The subject invention provides substantial advantages over the prior art. Van Den Berg (WO/1997/037123), shown in FIG. 1, requires two shallow water sea bed mounted pistons, rather than the one of the present invention, separated by an average wavelength. A gas tight chamber is maintained below each piston by a rolling membrane seal. The rolling membrane seal limits stroke and, therefore, energy capture and is vulnerable to frictional wear between the piston and cylinder and debris caught within the seal. The two pressurized gas chambers are connected to two pressurized gas accumulator tanks to slightly increase piston travel and rebound (by providing more compressed gas volume) rather than utilize the partial evacuation or surface or atmospheric venting of the present invention which allows several times more stroke and energy capture. Van Den Berg's piston connecting rods drive hydraulic pumps which drive a hydraulic motor and generator. All twin chamber devices spaced one average wavelength apart are inherently inefficient as wavelengths are very seldom at their average value. When waves are at 0.5 or 1.5 times average wavelength, such devices produce no energy. Submerged shallow sea bed mounted devices must be placed well below the average wave or swell trough depth to survive breaking waves in severe sea-states. Wave induced static pressure differences diminish rapidly with depth in shallow water. Shallow water sea bed mounted devices must be rugged to survive impacts from stones and sand due to breaking waves and, therefore, are costly as well as inefficient. Unlike the present invention, depth of sea bed devices can not be adjusted for tides or sea states.

Gardner (U.S. Pat. No. 5,909,060) also proposes a twin chamber shallow sea bed device which is essentially two inverted open bottomed cup shaped air entrapped vessels spaced an “average” wavelength apart and rigidly connected by an air duct. One vessel rises as the other falls (like a swing) pumping hydraulic fluid for an hydraulic motor generator. The device is called an “Archemedes Wave Swing.” A single vessel open bottom shallow sea bed mounted variant (FIG. 2) is also described, the upside-down air entrapped cup moves up and down in response to overhead wave induced static pressure variations driving a generator with a mechanical or hydraulic drive. Unlike the present invention, which uses an evacuated or surface or atmospheric vented closed vessel, Gardner's up and down movement, and therefore output and efficiency, is restricted because the vessel is not evacuated or vented to atmosphere. The entrapped air is, therefore, compressed restricting movement, efficiency, and output. The open bottom also presents problems such as weed fouling and air loss (absorption in water) not encountered in the closed vessel of the subject invention. Shallow water or sea bed mounting also raises costs and lowers efficiency as previously described in Van Den Berg above.

Gardner licensed U.S. Pat. No. 5,909,060 to AWS Ltd. which published an “improved” evacuated enclosed vessel design in November 2007 (as depicted in FIG. 3). Air under partial vacuum is entrapped between a moving rigid (heavy) inverted cylindrical cup shaped upper vessel (11 in down position, 12 in up position) which slides over a similar slightly small diameter stationary up oriented cup shaped vessel affixed to the sea bed. Partial vacuum is maintained by a “flexible rolling membrane seal” (14 in down position and 15 in up position). To prevent frictional seal wear and binding between the moving and stationary cup, an elaborate marine foulable “ectoskeleton” or frame 16 with rollers 17 or skids is required. The movable inverted cup drives a hydraulic piston 18 providing pulsed pressurized flow on each down stroke.

The present invention differs from the published AWS design of FIG. 3 in the following major ways:
1. The flexible elastomer bellows and smaller (plate not cup) light weight (fiberglass) moving surface of the present invention reduces total and moving mass several fold and is, therefore, several fold less costly (light weight flexible (elastomer) sidewalls vs AWS heavy rigid steel overlapping sidewalls). Low moving mass of the present invention greatly increases responsiveness allowing both wave and swell kinetic energy capture vs. the heavy AWS mass for swells only. Low moving mass also allows effective timing, or delayed release, of the compression and expansion strokes until the wave crest and trough, respectively, are overhead preserving precious stroke length until hydrostatic forces are at a maximum (for compression) and minimum (for re-expansion). This “latching” control alone can increase the energy capture efficiency of heaving mode OWECs several fold (see cited References Falnes & McCormick).
2. Certain preferred embodiments of the present invention use direct or indirect atmospheric venting, rather than the partial vacuum used by AWS which may be more difficult to maintain sea water leak free and may compromise internal hydraulic seals seeing vacuum. Partial vacuum also results in some gas compression resistance on the vessel compression stroke which reduces stroke somewhat and, therefore, energy capture.
3. Neither AWS or any other prior art submerged OWECs, utilize and overhead floats or buoys to enhance energy capture. Certain preferred embodiments of the present invention utilize surface floats, buoys or vent buoys mechanically connected to the submerged reinforced flexible bellows containers' moving second surface in such manner as to increase the containers' compression, and expansion, stroke and energy capture efficiency.
4. No AWS expensive, heavy, high maintenance, marine debris fouled ectoskeleton/cage with exposed rollers (to maintain concentric inverted cup over cup movement) is required for the present invention.
5. No AWS “flexible rolling membrane seal” (a fragile high wear, high maintenance, untested item) is required with the present invention. Partial container evacuation combined with hydrostatic seawater pressure draws this seal into the container interior reducing volume and increasing seal wear.
6. The membrane seal and concentric overlapping cups of the AWS device restricts stroke to less than half that of a present invention device of comparable size, halving cost and doubling energy capture.
7. The “rolling membrane seal” limits the AWS device to a circular horizontal planar section. An elongated section possible with the present invention, may be oriented transverse to the wave front direction (parallel to the waves) and, can capture more energy per unit of horizontal planar area and width. The sides of a circle have very little frontal area and capture very little wave energy.
8. The rigid near shore sea bed attachment post of the AWS device (19 in FIG. 3) does not allow depth adjustment for tides or optimized energy capture or protection from severe sea-states like the adjustable depth mooring systems of the present invention.
9. Embodiments of the present invention use a force multiplier or leveraged connecting means and/or multi-staged or multiple sequenced drive cylinders to increase stroke while maintaining higher capture efficiency than the AWS device (FIG. 3).
10. The device of the present invention, unlike the AWS device, can be oriented vertically (with either fixed or moving surface up), horizontally, to also capture lateral wave surge energy, or in any other orientation.

Burns (2008/0019847A1, 2007/025384/A1, and 2006/0090463A1) and FIG. 4 also describes a submerged sea bed mounted pressurized gas filled cylindrical container 11 having a small diaphragm 39 flexibly connecting a rigid movable top 25, 28 to the top of cylindrical side walls 17. The top and attached small diaphragm move slightly in response to overhead swell induced static pressure changes driving a leveraged 63 hydraulic pump 47. To overcome gas compression resistance and stroke limitations, Burns in some embodiments users multiple adjacent gas interconnected containers, but they are too close to each other to be effective (less than one half wave length apart). North U.S. Pat. No. 6,700,217 describes a very similar container and small diaphragm, but without gas evacuation, surface venting, multi-vessel interconnection or submerged gas accumulators.

The present invention overcomes the limitations of Burns and North in like manner to the AWS/Gardner limitations described in 1-10 above. More particularly or in addition:
1. Neither Burns nor North use surface or atmospheric venting or partial evacuation like the present invention to reduce container gas compressive resistance and thus increase stroke and energy capture efficiency several fold.
2. While Burns and North have less moving mass than AWS, their total mass (and therefore cost) is probably greater due to their heavy walled (11 and 17) ballasted sea bed mounted containers.
3. Burns' and North's small unreinforced diaphragms 29 severely limit their power stroke length to a small fraction of the overhead wave height and, therefore, a like small fraction of energy capture rather than the substantial or even majority stroke to wave height ratio of the present invention.
4. Burns' power stroke (and therefore energy capture efficiency) is limited by his return means, which use stroke limiting container internal gas pressure.
5. Burns' attempts to improve his poor stroke and energy capture efficiency in his latest application (2008/0019847A1) by aligning a series of containers into the direction of wave travel in an “arculated” shape allowing compressed container gas to flow between successive containers (like a gas accumulator) increasing compressed gas volume and thus increasing cost several fold.
6. Sea bed mounting of Burns' devices further severely reduces potential energy capture efficiency because sea bed mounting places Burns' movable device tops substantially below average wave trough depth due to tides and severe sea-state device protection considerations. Wave induced static pressure fluctuations fall off drastically with increased depth in shallow water as previously stated.

Meyerand U.S. Pat. No. 4,630,440 (FIG. 5) shows a submerged sea bed gas filled bladder 18 within a larger rigid sea water filled container 26. Meyerand's “bladder in a box” differs materially from the present invention's reinforced flexible bellows with one fixed rigid end surface and an opposing moving rigid end surface. Meyerand's bladder is connected via an air duct to a second shore or surface floating bladder 34. Sea water enters and exits the rigid container 26, in response to overhead wave induced pressure changes on the bladder 18, through a single opening pipe containing a sea water driven turbine-generator. Meyer '440 suffers the same limitations of near shore sea bed mounted hydrostatic pressure driven devices previously described. The long pneumatic hose 24 between the submerged container 26 with bladder 18 and the shore or surface based bladder 34 produces substantial pneumatic flow and efficiency losses. It also reduces the submerged bladder response time limiting energy capture to long swells and not waves. Most significantly, to get Meyerand's “constant pressure” bladder to reinflate when a trough is overhead (Meyerand's “return means”), the operating “constant pressure” must be extremely high to support and lift the water column above it (45 psi per 100 ft. of water depth). This high “constant pressure”, “constant volume” gas needed for submerged bladder reinflation has high compressive gas resistance and severely limits submerged bladder volume changes and, therefore, energy capture. The present invention does not use high pressure gas within the container and surface bladder as its' return means. The container gas pressure is approximately one (1) atmosphere or lower allowing several times more stroke and energy capture.

Margittai (U.S. Pat. Nos. 5,349,819 and 5,473,892) describes a flexible gas (air) filled submerged (sea bed placed) container which expands and contracts in response to overhead wave induced hydrostatic pressure changes. The rigid top surface is rigidly affixed to and drives a vertical 1 stroke se water open cycle pump. Unlike the present invention, Margittai does not vent or evacuate his container (he actually “inflates” or pressurizes it to hold its shape and provide his return or re-expansion means, thereby limiting his stroke and wave energy absorption several fold. Margittai uses a simple bladder unreinforced against external hydrostatic pressure, unlike the “reinforced bellows” of the present invention (reinforced against both internal vacuum and external hydrostatic pressure), it is reinforced by his internal air pressure. Margittai relies upon severely stroke and efficiency limiting internal air pressurization for his return means rather than the mechanical or hydraulic return means of the present invention.

### BRIEF DESCRIPTION OF THE DRAWINGS

FIG. 1 is a submerged elevation sectional view of the Prior Art by Van Den Berg 1997/037123.

FIG. 2 is a submerged elevation sectional view of the Prior Art of Gardner U.S. Pat. No. 5,909,060.

FIG. 3 is a submerged elevation sectional view of the Prior Art of AWS Ltd. as described in the published 29 October-11 November “The Engineer” (pgs. 26 and 27).

FIG. 4 is a submerged elevation sectional view of the Prior Art by Burns (2008/0019847A1).

FIG. 5 is an elevation view of Meyerand U.S. Pat. No. 4,630,440.

FIG. 6 is a submerged elevation sectional view of one embodiment of the present invention comprising a ring reinforced flexible bellows vertical moving axis partially evacuated gas filled container, a hydraulic piston pumping means, a scissor-jack force multiplier/stroke reducer and spring return means.

FIG. 7 is a submerged isometric sectional view of one embodiment of the present invention comprising an elongated reinforced “accordion pleat” flexible bellows vertical partially evacuated gas filled container, a bellows hydraulic or pneumatic pumping means and scissor-jack force multiplier with spring return means.

FIG. 8 is a submerged elevation sectional view of one embodiment of the present invention comprising a single gas tight horizontal axis partially evacuated gas filled cylindrical container with two opposing internal ring reinforced diaphragms, two bellows hydraulic or pneumatic pumping means and two scissor-jack force multiplying means with two spring return means, said bellows pumps optionally also acting as spring return means.

FIG. 9 is a submerged elevation sectional view of one embodiment of the present invention comprising two vertical axis ring reinforced flexible bellows, gas tight containers sharing a common surface float atmospheric direct discharge/intake vent, two scissor-jack force multiplying means, two sea water open cycle bellows hydraulic pumping means, feeding a single pressurized accumulator tank with air diaphragm pressure and flow regulator and one hydraulic turbine generator.

FIG. 10 is a submerged elevation sectional view of one embodiment of the present invention comprising a ring reinforced flexible bellows vertical axis partially evacuated gas filled container, a linear electric generator driven by a connecting means magnetic rod and a coil spring return means around said rod.

FIGS. 11a and 11b are submerged elevation sectional views of a ring reinforced flexible bellows vertical axis partially evacuated gas filled container of the present invention with coil spring return means, a two (2) stroke hydraulic piston pumping means, and an expandable hydraulic working fluid pressure and pulse reducing high pressure accumulator tank, which with a series of one way (check) valves maintains constant uniform high pressure flow to a hydraulic motor or turbine generator. FIG. 11a shows the fully compressed bellows (wave overhead) starting its return stroke. FIG. 11b represents a fully expanded bellows (trough overhead) starting its downward stroke.

FIG. 12 is a submerged elevation sectional view of the present invention with a flexible thin section spring bellows partially evacuated gas filled container of the present invention and a connecting means with return means coil spring direct driving, via a linear helix drive, a rotating generator.

FIG. 13 is a submerged elevation sectional view of a flexible thin section vertical axis bellows gas filled container of the present invention with two (2) stroke piston hydraulic pumping means and spring return means, said container's gas being in communication with a floating surface expandable bellows or bladder, said float providing additional bellows compression force via connecting cables when lifted by surface waves.

FIG. 14 is a submerged elevation sectional view of an inverted (moving surface below fixed surface) vertical axis flexible thin section air filled bellows container of the present invention with piston hydraulic pumping means and spring return means, said container's air being in direct communication with a surface air vent on a surface float, said float providing additional bellows compression via cables or beams when lifted by surface waves.

FIG. 15 is a submerged elevation sectional view of a flexible ring reinforced bellows vertical axis partially evacuated gas filled container of the present invention with hydraulic piston pumping means, scissor-jack force multiplying means, a gas diaphragm pressurized hydraulic fluid reservoir surrounding said piston's cylinder, a sealed thin section gas filled spring bellows tidal depth adjustment device on the anchoring means.

FIG. 16 is a submerged elevation sectional view of the present invention with an internal ring reinforced laterally stabilized flexible reinforced elastomer vertical axis partially evacuated container with coil spring return means, multi-stage hydraulic drive cylinder, lateral load slide tube or rails, two drag or depth stabilization discs, tidal or sea-state depth adjustment jack-screw, rigid mooring spar or mast, multi-point deep water anchoring means and sealed sea bed hydraulic power pod with high pressure accumulators and hydraulic motor-generator set.

FIG. 17 is a submerged vertical section isometric view of the present invention showing multiple vertical axis partially evacuated gas filled elongated reinforced flexible elastomer bellows or accordion pleated bellows containers, sharing a common fix depth base, each elongated container having multiple hydraulic drive cylinders with said common elongated base held parallel to prevailing waves by a plurality of mooring masts or lines.

FIG. 18 is a vertical sectional view of the present invention with either one or two submerged inverted vertical gas filled flexible bellows connected through a common movable end surface to a rigid gas duct length connected at the other end to a surface floating expandable bellows or bladder with a pneumatic turbine-generator being driven by gas oscillating between said submerged bellows and said floating bellows or bladders.

### DESCRIPTION OF PREFERRED EMBODIMENTS

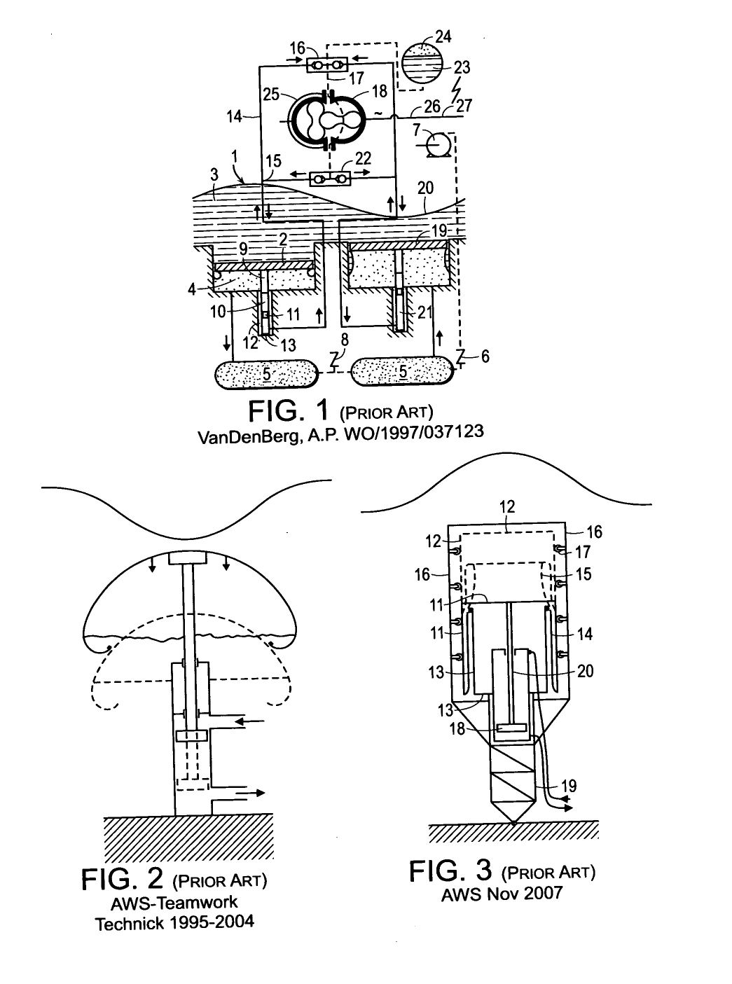

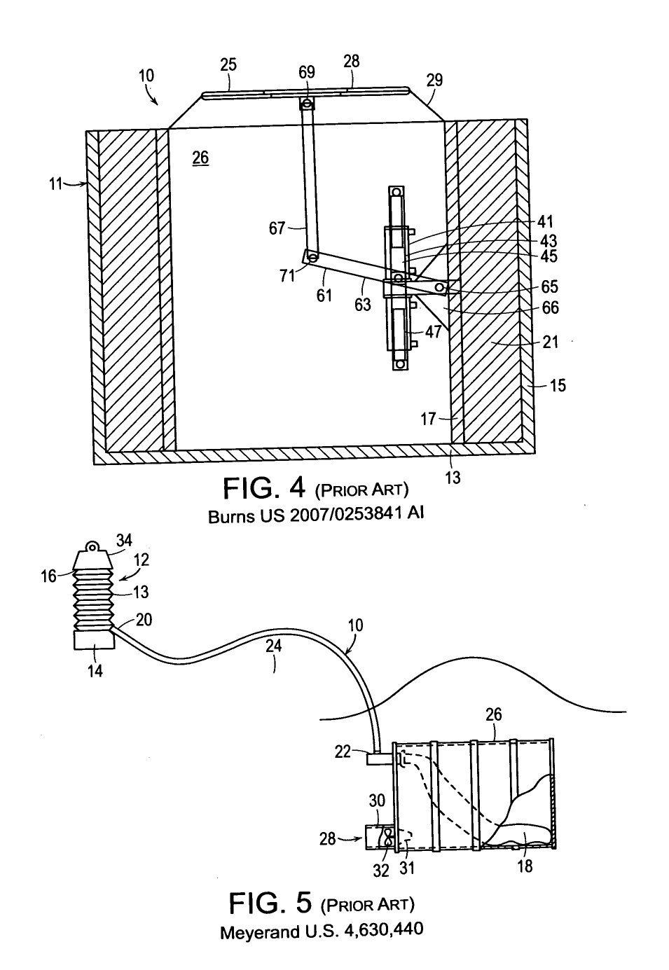

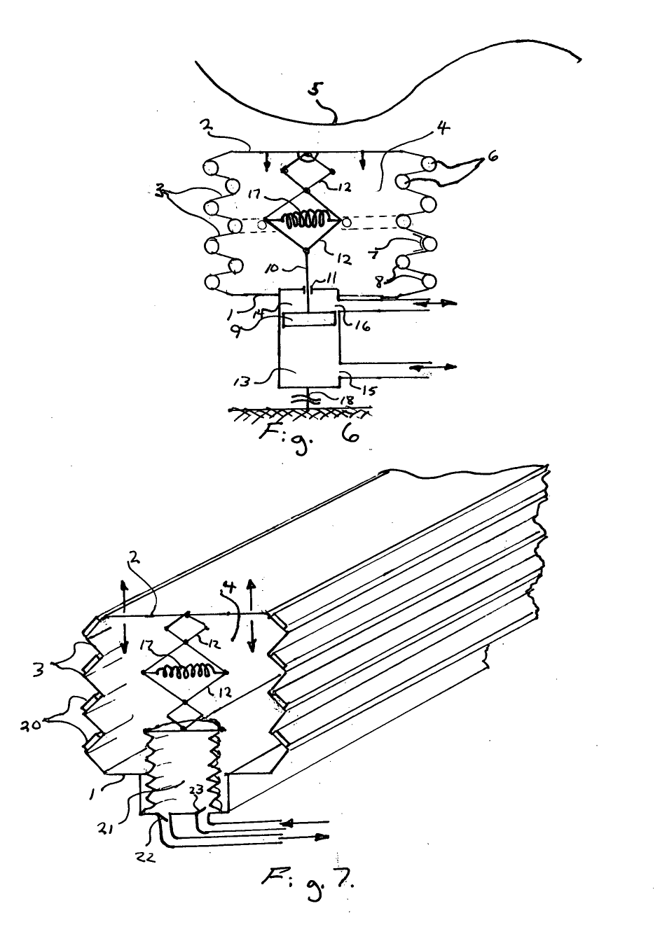

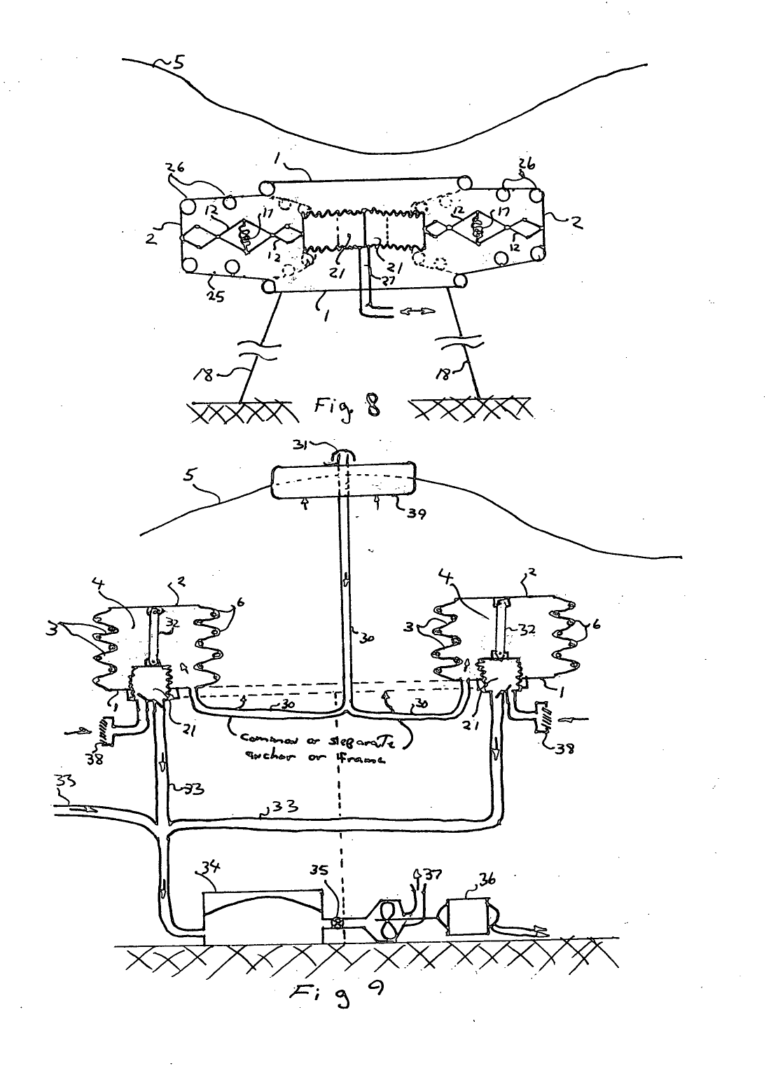

FIGS. 1-5 show prior art previously discussed herein. It should be noted that any of the embodiments of the present invention of FIGS. 6-18 can use partial evacuation of said containers or surface venting (snorkel vent or bellows) and any of these embodiments can be enhanced by mechanically connected surface floats or buoys. FIG. 6 shows one embodiment of the present invention utilizing a submerged gas tight flexible elastomer impregnated fabric reinforced bellows 3, reinforced against partial internal vacuum and external hydrostatic pressure, affixed and sealed to a movable rigid upper surface 2 slighting below a wave trough 5 and a relatively fixed depth lower surface 1. Surfaces 1, 2 and 3 form a vertical axis gas tight container which can be circular or oblong in planar section. Rigid surfaces 1 and 2 may be fabricated of relatively light weight steel or fiber reinforced plastics (FRP) to maintain low weight and cost. The interior volume 4 of said container is partially evacuated (shown) or vented to atmosphere or to a bladder or accumulator (as subsequently shown in FIG. 9, 13, 14 or 18) such that the downward movement of the upper surface 2 is increased and the container's internal gas pressure is not substantially increased which would cause a high compressed gas resistive force when a wave moves over said container, thereby increasing the hydrostatic pressure around said container and compressing it. Partial evacuation is easily achieved by fully compressing said bellows 3 prior to or during initial submergence and allowing excess gas (or air) to escape through a one way or check valve (not shown). The flexible elastomer impregnated fabric reinforced bellows 3 can be made using materials and fabrication methods utilized in high speed off shore Coast Guard or Navy inflatable boats, automobile tires or industrial conveyor belts, including synthetic rubber or urethane impregnated nylon, steel, polyester or kevlar fabrics. The flexible bellows 3 is reinforced with metal or fiber reinforced plastic (FRP) rings 6 to preserve its shape under both internal vacuum or pressure and external static pressures, which rings can be either embedded into said bellows fabric 7 or placed into bellows recesses 8. The smaller diameter rings (6 lower and 8 upper) are not required if the container interior is sufficiently evacuated or surface vented such that external hydrostatic pressure always exceeds internal pressure. A full scale bellows, if round in horizontal planar section, may have a typical diameter and stroke of 5-10 meters producing an output of 0.25 MW to 1 MW in typical northern latitude sea-states. An elongated bellows may have a width and output of several times that.

A double acting (2 power strokes) hydraulic piston pump 9 is attached to the rigid container's fixed end 1. The pump's piston rod 10 passes through a seal-bearing 11 and is connected to a force multiplying, piston stroke reducing scissor-jack 12, which jack is connected to the container's upper movable surface 2 at its' other end. The bellows container in FIG. 6 is shown in its fully expanded state with a wave trough 5 or swell trough overhead. As a wave progresses overhead, the bellows is subjected to increased hydrostatic pressure from the weight of the overhead waves compressing the bellows with rigid movable surface 2 travelling towards fixed surface 1 with said scissor-jack 12 moving said piston 9 downward pressurizing and expelling pneumatic or hydraulic fluid in lower pump chamber 13 through lower port 15 and drawing in fluid through upper port 16 into upper pump chamber 14. As each overhead wave recedes and external static pressure decreases, the bellows 3 again expands aided by a return spring 17 as well as the compression induced increased internal pressure in the container 4. Control valves (not shown) on hydraulic liners 15 and 16 in communication with hydrostatic pressure sensors and a programmable computer (not shown) can delay said piston 9 down stroke until the wave crest is fully overhead, thereby substantially increasing energy recovery. Bellows reinforcing rings 6 and 8 can be a single helix and thereby also serve as return springs. The pneumatic or hydraulic pressurized flow in and out of pump ports 15 and 16 can be open or closed cycle, and can be oscillating or one way via appropriate placement of one way or check valves. The pressurized fluid can drive a local or remote hydraulic motor or turbine generator for power generation. The scissor-jack 12 both increases the hydraulic fluid pressure (reducing the size of the entire hydraulic power take off system) and reduces the stroke of piston 9. Ideally, the displacement of the container movable top 2 should be half the wave height thus fully collapsing each approaching wave and producing a flat water surface with no remaining potential energy. The container fixed surface 1 is kept in a relatively fixed position relative to the sea bed or mean water level either by a cable 18 fixed to the sea bed in combination with the buoyancy forces of the container or a rigid pole optionally hinged at its' sea bed and container attachment points.

FIG. 7 is a submerged flexible vertical axis partially evacuated bellows container similar to FIG. 6 except it is elongated and maintained transverse to the approaching wave front, parallel to waves (via upper surface mounted or trailing vertical fins or anchoring at two or more points in the prevailing wave direction). The bellows reinforcing rings 6 of FIG. 6 are replaced by longitudinal attached external (shown) slats or internal slats (not shown) 20 of metal, FRP or other rigid material. The ends of the elongated bellows can be semi-circular and internally supported by half rings or hoops as previously shown or the bellows ends can be rectangular using “accordion pleats” again with slats as previously described. The rigid moving top 2 and fixed bottom 1 can also be of metal or FRP. The scissor-jacks 12 drive a metal spring bellows type pneumatic or hydraulic pump 21 (rather than the piston pump 9 of FIG. 6) providing sealing advantages especially if the container 4 is partially evacuated. Pump output 22 and intake 23 ports are fitted with one way valves to produce one way rather than oscillating two way working fluid flow as in FIG. 6.

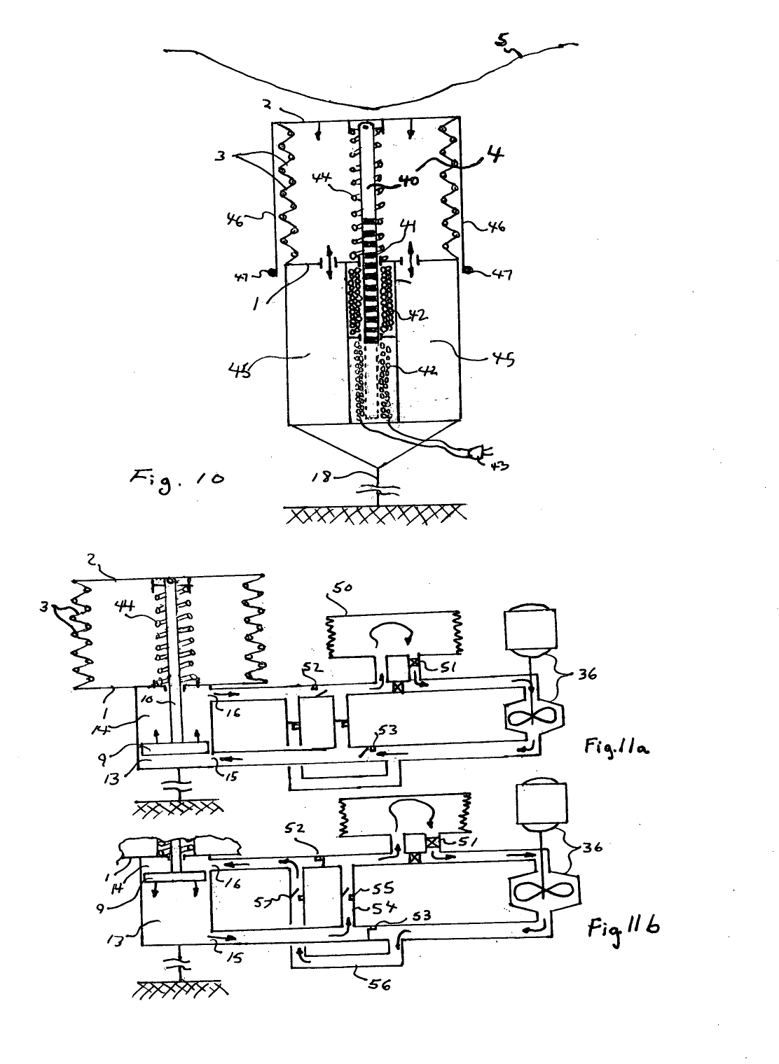

FIG. 8 differs from FIGS. 6 and 7 by having a container comprising a single rigid fixed surface 1, which is horizontally oriented and cylindrical, and two rigid movable surfaces 2 and two internally reinforced flexible surfaces 25, which are flexible diaphragms with attached internal metal or FRP supporting hoops or rings 26 (shown) or a flexible reinforced bellows (as previously shown). Upon overhead wave induced compression of the container 2, scissor-jacks 12 compress two fluidic spring bellows pumps 21 producing two way (shown) or one way (as shown in FIG. 7) working fluid flow for driving a motor-generator, turbine-generator or other uses.

FIG. 9 shows another embodiment of the subject invention where two or more submerged flexible bellows containers 4 of similar construction to FIG. 6 are vented to atmosphere through vent ducts 30 to one (shown) or more (not shown) buoy 39 mounted surface vents 31. Such venting, like the container partial evacuation previously described, reduces internal container pressure upon compression via an overhead wave 5 allowing a longer stroke (and therefore more energy capture) of moveable surfaces 2 driving bellows pumps 21 via connecting rods 32. The metal spring bellows pump 21 also provides the return force means to re-expand bellows 4 between waves 5. Pressurized output 33 from multiple pumping means 21 provide pressurized fluid flow to a submerged or shore based diaphragm accumulator tank 34 which with an exit flow control valve 35, provides continuous (non-pulsating) flow to a turbine-generator. An open sea water hydraulic cycle is shown which could also be a closed hydraulic or pneumatic cycle if the turbine outlet 37 were piped back to the bellows pump 21 inlets 38.

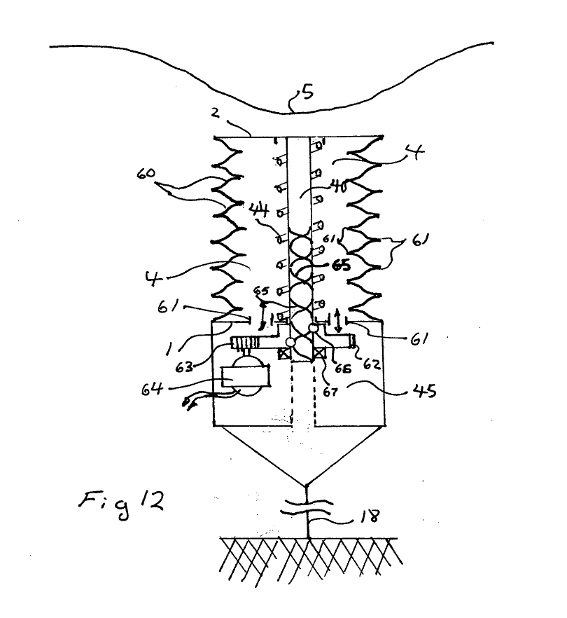

FIG. 10 shows an embodiment of the present invention using a submerged flexible reinforced bellows as described in FIG. 6. A movable top surface 2 moves downward toward a bottom fixed surface 1 as a wave 5 passes overhead and drives a connecting tube or rod 40 with alternating pole permanent magnet sections on its lower end 41 through one or more circular windings of wire 42 forming a linear generator and producing an alternating current for delivery 43 to conventional power conditioning equipment and a sea cable to shore (not shown). A helical return spring 44 around said connecting tube 40 assists in returning said top surface 2 and re-expanding said bellows 3 after each wave passes. Gas pressure, in said partially evacuated container 4 and a continuous helical bellows reinforcing ring-spring (as previously described in FIG. 6) may also assist in such return. An annular floatation collar or tank or chamber 45 in communication with container 4 interior can provide both additional buoyancy to keep said containers fixed end 1 at a relatively constant depth and can also serve as an expansion chamber for gas in the containers interior 4 during the compression stroke where a wave 5 moves overhead. Said expansion chamber compressed gas can also provide some of the return means of the movable surface 2 assisting return spring 44. Bellows 3 is optionally covered with a thin flexible or rigid plastic or elastomer skirt 46 with bottom weights 47 for protection from marine fouling and debris.

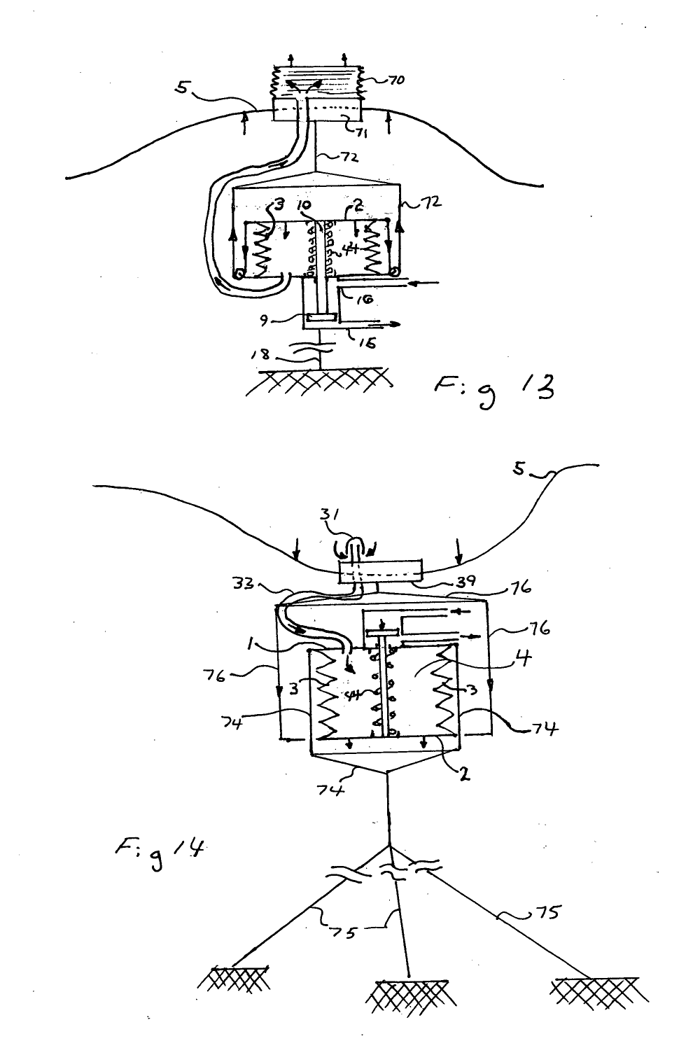

FIG. 11a shows a submerged flexible reinforced bellows 3 container of the type previously described driving a hydraulic or pneumatic piston 9 in a closed cycle. As said bellows starts to expand as an overhead wave passes away, the piston starts up driving pressurized fluid from the upper pump chamber 14 past one way check valve 52 into an expandable accumulator bladder or tank 50. Said pressurized fluid exits said accumulator 50 through a control valve 51 before passing through a turbine generator 36 and returning through a second check valve 53 into lower pump chamber 13.

FIG. 11b shows the same device of FIG. 11a when an overhead wave starts to pass over an expanded bellows 3 starting piston 9 on its downward stroke pressurizing and expelling fluid in lower pump chamber 13 out through lower port and line 15 and then through transfer line 54 and through open flow check 55 (because 53 and 52 are now closed) and into said expandable pressurized accumulator tank 50 before exiting through flow control valve 51 to the turbine generator 36. Lower pressure fluid exiting the turbine 36 returns to the pump upper chamber 14 through crossover line 56 and through flow check 57. This combination of valves, piping and expandable accumulator is but one of several configurations producing continuous high pressure flow to a turbine or hydraulic motor from the intermittent flow of a reciprocating two stroke pump. Control valves can be substituted for check valves 52 and 55 such that the down stroke and return stroke of piston 9 is delayed or “timed” or “latched” by these valves until the overhead wave is producing maximum down force as indicated by hydrostatic sensors. This substantially increases energy capture efficiency by preventing premature stroking (cited reference to Falnes & McCormick).

FIG. 12 shows an embodiment of the present invention using a submerged partially evacuated flexible thin metal or plastic (reinforced or unreinforced) spring bellows 60 container rather than the ring reinforced elastomer or rubber impregnated fabric reinforced flexible bellows previously described. A metal bellows can be of a marine grade stainless steel, aluminum or other metal with good flex fatigue and marine anti-corrosion properties. It is preferably of 0.30 to 3.0 mm thickness. It may have flat welded or crimped joints 61 as shown or rounded rolled and sealed gas tight joints (not shown) like high temperature stainless steel expansion joints. A flexible plastic bellows may be made out of unreinforced engineered plastics such as acetyl, polycarbonate, nylon, urethane, or high density polyethylene or thin section fiber reinforced plastics (FRP) including polyester, vinalester, epoxy or urethane impregnated glass, nylon, polyester, carbon or Kevlar fiber. Flexible FRP bellows will typically be of 0.5 mm to 5 mm thickness. Regardless of material, the bellows and other device external surfaces may have a Teflon or other marine anti-fouling surface coating. The container's rigid movable top surface 2 and fixed bottom 1 may be of molded rigid FRP or fabricated metal. As in FIG. 10, an expansion or buoyancy chamber 45 is attached to said bottom 1 and in gas communication with the bellows interior 4 through gas ports 61. Said expansion chamber 45 may also house drive gears 62 and 63 and generator 64. Said bellows interior 4 and expansion chamber may be under partial vacuum in the expanded position under a wave through 5 as shown or during both expanded and compressed position (not shown) as a wave passes overhead to further increase stroke and energy absorption. A linear helix drive 65 is driven up and down by moving surface 2 turning main drive gear 62 supported on thrust bearings 67 which is driven by internal ball bearings 66 riding in helix drive 65 helical grooves. Known helix linear drives can convert linear motion to one way rotary motion (like a toy top), with or without a fly wheel, or reciprocating two way rotary motion on either the down stroke only (again like a toy top) or on both the down and return stroke. The return means is either internal gas pressure within the bellows 4 and chamber 40 or return spring 44 or the natural spring properties of the spring bellows 60.

FIG. 13 shows an embodiment of the present invention in which the submerged vertical axis bellows 3 container shown in the compressed position is vented (as in FIG. 9) to a floating surface gas tight flexible bellows or bladder chamber 70 on float 71. Such surface bellows or bladders being under approximately atmospheric pressure or a moderate pressure under 30 psig insufficient to reinflate said submerged containers without return springs 44 or other means. Cables (shown as 72) or connecting rods and compression levers (not shown) attached to said floating buoy 71 together with the increased static pressure from overhead wave 5 compress said bellows 3 driving said upper movable surface 2 down. The upper movable surface 2 is connected by piston rod 10 to a pump piston 9, as in FIGS. 6 and 11, producing pressurized fluid flow out of pump ports 15 and 16 for power generation or other uses. A return spring 44 or spring bellows 3 (as previously described) provides the return means allowing pumped flow and power recovery on both the down and return stroke. Said bladder 70 can serve as the entire buoy providing increased buoyancy as each wave passes overhead as it fills with gas pushed out of said submerged container thus increasing volume and the buoyant force it transfers through 72 to piston 9.

The embodiment of FIG. 14 is similar to FIG. 13 except the submerged vertical axis bellows container is inverted placing said rigid moving surface 2 on the bottom and said fixed surface 1 on the top. Stationary cables or rods 74 plus the buoyancy of the container 4 hold said fixed surface 1 at a relatively constant depth. A three cable anchoring means 75 affixed to the sea bed plus container buoyancy prevent said container from moving laterally in currents which would otherwise alter its depth. A second set of cables 76 (shown) or connecting rods (not shown) connect said moving surface 2 to a surface float 39 or buoy thus increasing the compression of flexible surface 3 when waves 5 or swells pass overhead. Said container's interior 4 is vented through vent duct 33 to the atmospheric vent 31 like FIG. 9 on said buoy 39 further increasing the compression stroke and hence power output by avoiding the build-up of pressurized gas in said container's interior 4. Return means are the same as FIG. 13. Alternatively, vent float 31 could be replaced with the expandable gas bellows or bladder float 70 and 71 of FIG. 13.

The floats 71 and 39 of FIGS. 13 and 14 may be replaced by any other surface floating object with or without said vents or bladders including any floating Ocean Wave Energy Converter (OWEC).

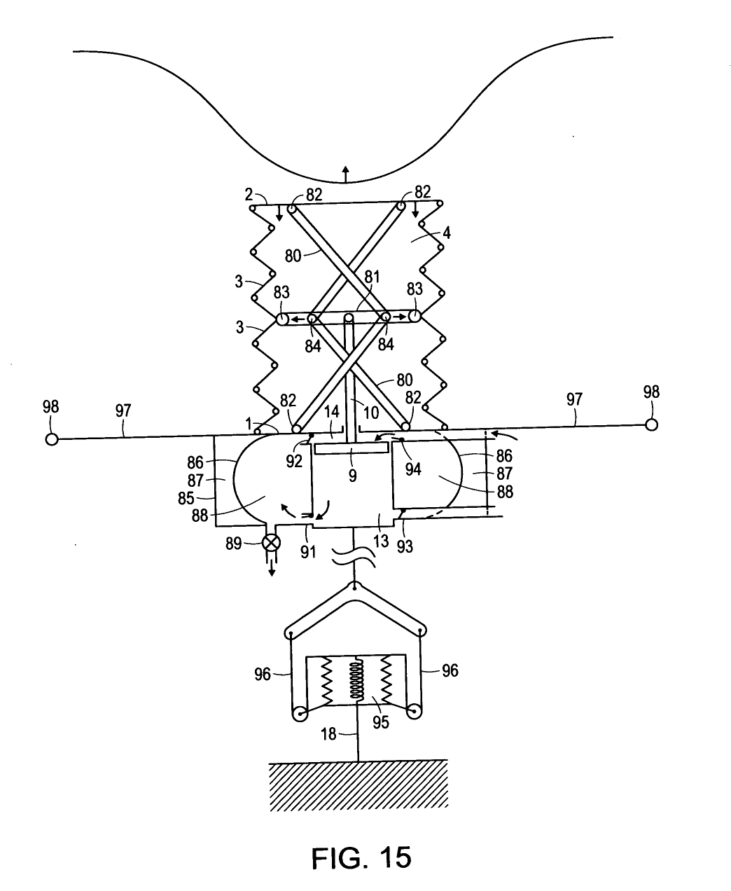

FIG. 15 shows an embodiment of the present invention similar to FIGS. 6, 7 and 11 whereby a scissor-jack force multiplier/stroke reducing means 80 connects said container's rigid moving surface 2 to said pumping means 9 through a piston connecting rod 10 at the center of a bellows 3 stabilizing cross track 81. The scissor-jack differs from that of FIGS. 6, 7 and 8 in that there are two (not one) connecting points 82 to both the movable surface 2 and fixed surface 1. This maintains parallelism between surfaces 1 and 2 during said bellows 3 compression and expansion. Said stabilizing crossbar 81 further laterally stabilizes said bellows 3 by connecting to bellows 3 at connecting points 83. Scissor-jack hinge joints 84 have attached rollers which are contained within cross channel 81 and slide with low friction laterally as said bellows 3 is expanded and contracted. While FIG. 15 shows only one horizontal crossbar 81, additional cross channels can be added as needed to further stabilize said bellows 3.

Also shown is an annular pumped working fluid accumulator tank 85 surrounding pumping chambers 13 and 14 and abutting container rigid fixed surface 1. It contains a diaphragm 86 and gas filled expansion volume 87 which volume supplies additional buoyancy to stabilize container fixed end 1. Pressurized working fluid exiting pumping chambers 13 and 14 through exit ports 91 and 92, respectively fill said accumulator volume 87 expanding said membrane diaphragm 86. Pressurized steady (non-pulsing) flow working fluid exits through control valve 89 to a motor or turbine generator or for other uses. Low pressure working fluid enters pumping chambers 13 and 14 through inlet ports 93 and 94 respectively. The working fluid cycle may be open or closed.

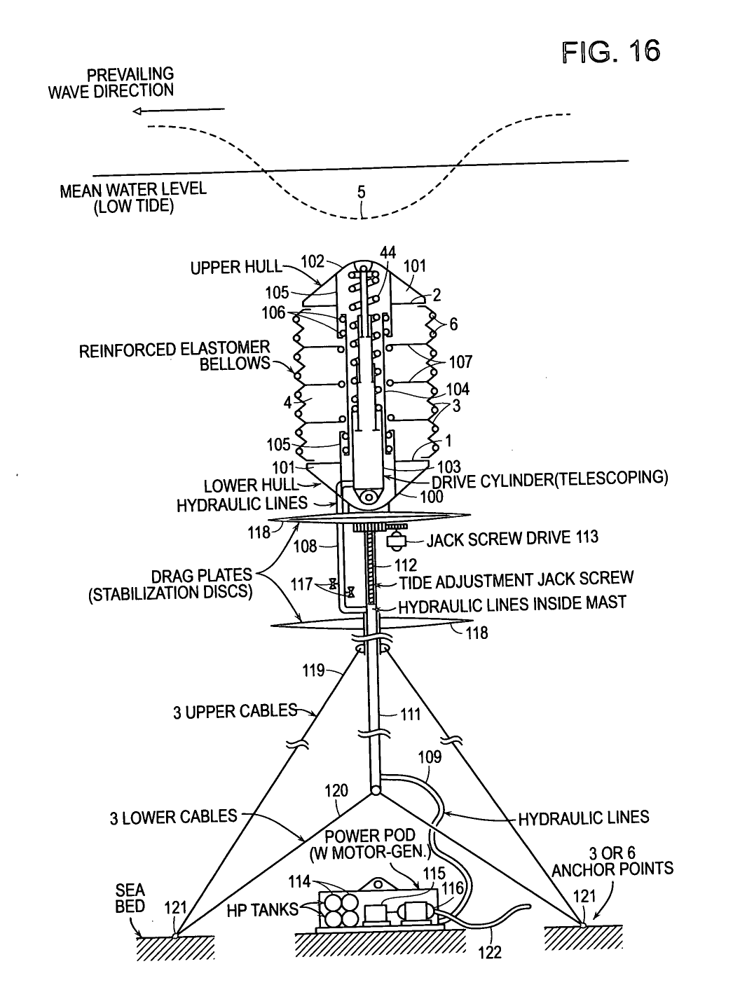

Between the sea bed anchor cable 18 and said container lies a hydrostatic (shown as 95) or electro-mechanical depth adjustment means (not shown) which responds to high and low tide by lengthening or shortening, respectively one or more connecting cable lengths such that the expanded depth of moving surface 2 remains at approximately the same distance below the mean water level or wave troughs during all tides. A supplementary device can sense extreme sea-states and further reduce anchor cable length to provide added protection. A stabilization plane 97 made of metal, FRP or elastomer impregnated fabric with outer support frame 98 or tube can be used if required to further stabilize said fixed end 1 of said container as container vertical bobbing will shorten the stroke and hence power recovery efficiency. Said plane 97 may be affixed to stationary surface 1 (shown) or placed on a mast or spar or the cable below it (as shown in FIG. 16).

FIG. 16 shows an embodiment of the present invention similar to FIGS. 6, 7, 11 and 15. Stationary surface 1 (sealed to a reinforced flexible bellows 3) is part of a molded or fabricated lower hull 100 which may have integral buoyancy chambers 101 which may also serve as a high pressure accumulator (previously described in FIG. 15) or expansion chambers (per FIG. 10 or 12). Moving surface 2 is part of upper hull 102 which may also contain buoyancy chambers 101 which may also serve as expansion chambers. Flexible bellows 3 is supported against external hydrostatic pressure by (internal only) support rings 6. Bellows expansion return is via returns spring 44 which return can be assisted or replaced by the 3 stage telescoping hydraulic drive cylinder 103. Said bellows 3 and drive cylinder 103 are protected from severe lateral loads and deflection if required by an internal central slide tube or rails sliding within mating tubes or rails 105 in both the top and bottom hulls. Such sliding is facilitated by rollers or bearings 106. The bellows 3 is further supported against lateral or shear loads by cross members 107 also rolling on said slide tube or rails 104. The drive cylinder 103 is hydraulically connected to a sea bed mounted “power pod” 110 via hydraulic lines 108 and 109 passing through a rigid mast or spar. Said power pod can service multiple said bellows container devices. The upper mast 111 houses or supports a tidal depth adjusting jack screw 112 driven by electric or hydraulic jack screw drive 113. Said power pod is sealed against sea water and houses high pressure hydraulic fluid accumulator tanks 114, hydraulic motor 115, electric generator 116, and controls (not shown). The hydraulic circuit contains control valves 117 on high pressure supply and low pressure return lines which may be used to delay or time the drive cylinder 103 power (down) stroke and return stroke until the wave 5 crest or trough (shown), respectively, are overhead, for maximum stroke length and energy capture (per cited reference Falnes & McCormick). Fixed surface 1 is held in deep water at a relatively fixed depth by the buoyancy of the gas filled bellows container 4 and any buoyancy chambers 101 and multiple drag planes, plates or discs 118. Said spar 111 and said container can be held in a relatively vertical position by three or more upper cables 119 and three or more lower cables 120 affixed to three or more anchor points 121.

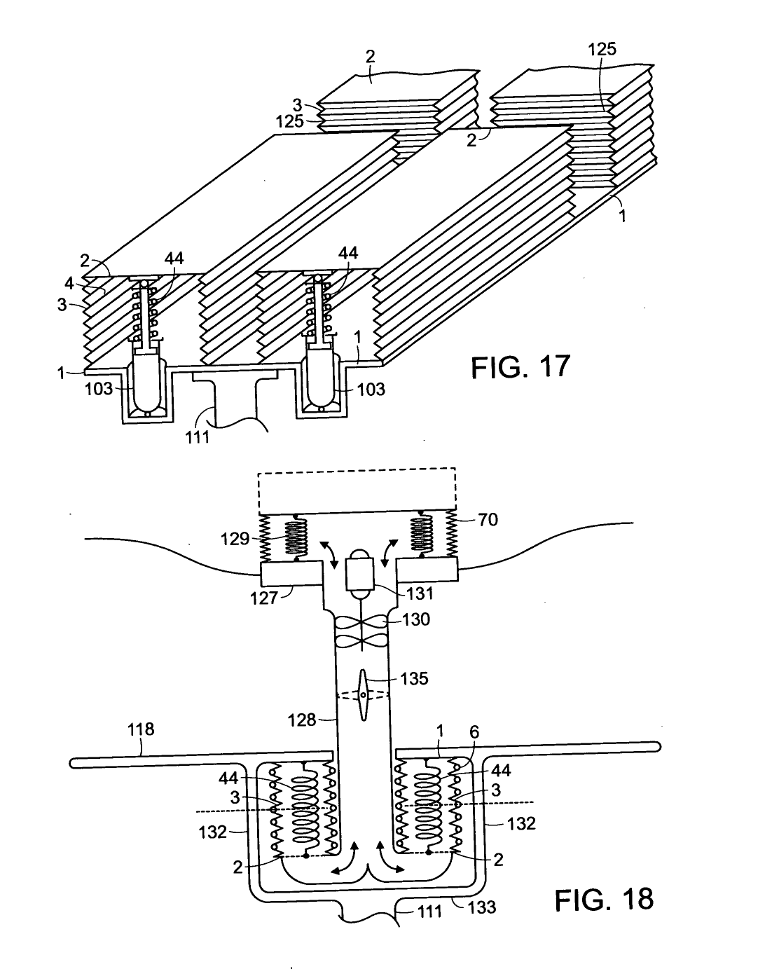

FIG. 17 shows an embodiment of the present invention whereby two or more elongated said bellows containers 4 (like FIG. 7) with movable upper surfaces 2 share a common fixed base 1. Said containers interiors 4 are at least partially evacuated (like 6, 7, 8, 10, 11, 12, 15 & 16) when said containers are in their extended or expanded position (under a wave trough). Said containers utilize their one or two stroke hydraulic drive cylinders 103 for energy capture and bellows re-expansion (return means) assisted optionally by return springs 44. The elongated bellows 3 (like FIG. 7) can use accordion pleats 125 or internal half ring supported ends (not shown). Like FIG. 7, this multiple elongated container device can, like FIG. 7, be held parallel to oncoming prevailing wave fronts by two or more masts or spars 111 either fixed to the sea bed or suspended above it with multiple cables per FIG. 16 or via vertical fins affixed to moving surface 2 or trailing said container.

FIG. 18 utilizes a surface vented embodiment of the present invention per FIGS. 9, 13 and 14. Like FIG. 14, a single vertically oriented bellows container is inverted with the moving surface 2 down and the stationary or fixed surface 1 up. Rather than use the cables or rigid tie rods (76 of FIG. 14) of FIG. 14 to rigidly attach moving surface 2 to the “active” vent float or buoy 127, a rigid vent duct 128 protruding through a center hole in said bellows container 4 or between adjacent elongated containers provides said rigid attachment. The vent buoy uses an enclosed expandable bellows 70 (like FIG. 13) or bladder, rather than an atmospheric snorkel type vent like FIG. 14 although either may be used. Return means for re-expansion of said bellows chamber is by return springs 44 in said submerged bellows containers optionally assisted by springs 129 in said surface floating bellows 70. Power take off can be via hydraulic means (as shown and described in FIGS. 6, 7, 8, 9, 11, 13, 14 15, 16 and 17) or by pneumatic means using a bi-directional air turbine 130 driving an electric generator 131. Surface 1 is held at a fixed depth by rigid tie rods 132 and rigid frame 133 connected to a mast 111 and mooring system, as previously described for FIG. 16. Container buoyancy and drag discs 118 provide additional vertical stability to fixed depth surface 1. A control damper valve 135 in duct 128 provides “latching” control delaying the compression and expansion strokes for maximum forcing and energy capture efficiency.

Modifications or improvements to or combinations of the concepts described herein may be made by those skilled in the art without departing from the scope of the present invention.

I claim:

1. A wave energy converting device for extracting energy from a water body with surface waves or swells and troughs comprising:
a. One or more substantially submerged gas tight containers under hydrostatic pressure, holding a gas under atmospheric or moderate pressure or partial vacuum, said container(s) having at least three surfaces, one or more rigid first surfaces being held at a relatively fixed depth and one or more rigid second surfaces being distant from, not overlapping and forming a gap between said rigid first and second surfaces and being movable relative to said first fixed surfaces and one or more flexible third surfaces spanning said gap and attached to and forming said gas tight containers with said first and second surfaces, said third surface being flexible over a majority of the length of said gap, such flexibility being suitably reinforced to prevent collapse inward from said hydrostatic pressure or said vacuum while allowing said movement of said second surface relative to said first surface, such movement or stroke decreasing or increasing the volume of said containers and the distance or gap between said first fixed and said second movable surfaces, said decreasing or increasing the distance being caused by increased or decreased hydrostatic pressure as waves or swells and troughs, respectively, pass over said containers, which container's axis of movement may be oriented in any direction; and
b. Said majority of said third flexible surface being either a thin section flexible metal or plastic bellows, or a reinforced flexible elastomer bellows, or accordion pleated bladder, or diaphragm with said reinforcings being a plurality of rigid reinforcing rings or hoops or, slats or other rigid reinforcements oriented generally transverse to the direction of movement between said first rigid surfaces relative to said second rigid surfaces and being inside or attached to said flexible elastomer bellows, bladder or diaphragm and so arranged to withstand the inward collapse of said flexible third surfaces from said containers' said internal vacuum or pressure and said wave and submerged depth induced external hydrostatic pressure; and
c: Said containers' said gas being under said partial vacuum when said containers' volumes are increased or said gas being in direct or indirect communication with atmospheric pressure through one or more surface vent buoys or atmospheric or moderate pressure trough floating surface expandable bellows or bladders, which substantially reduce the compression resisting pressure of said gas in said submerged container(s) when said container(s) volumes are reduced and thus increasing the total wave and trough induced compression and expansion stroke between said first fixed and said second movable surfaces by reducing the compressed pressure of said gas within said containers; and
d. Hydraulic or pneumatic pumping means for power generation or other uses or mechanical or electrical drive means all within or in communication with said containers and driven by said relative movement between said first and said second surfaces or said expansion or contraction of said containers; and
e. Hydraulic, pneumatic, mechanical or electrical return means for returning said containers from said decreased volume compressed position to said increased volume expanded position when said wave or trough induced hydrostatic pressure is reduced; and
f. Anchoring, mooring or other depth and location fixing means for holding said containers said first fixed surfaces at a relatively fixed depth relative to the sea bed or said water body mean level or said wave trough average level.

2. The device of claim 1 wherein said hydraulic or pneumatic pumping means from one or more said containers provides pressurized fluid to one or more power generating means within or attached to said containers or remote from and in communication with said containers via hydraulic or pneumatic lines or ducts said power generating means comprising hydraulic or pneumatic motors or turbines receiving pressurized fluid either directly from said pumping means, or from pressurized accumulators or reservoirs for reducing flow and pressure fluctuations to said turbines or motors.

3. The device of claim 1 wherein said hydraulic or pneumatic pumping means can operate upon either said container's compression stroke or in combination with said return means on both said compression and subsequent expansion stroke by said return means.

4. The device of claim 1 wherein said containers contain or are in communication with a control means and a hydrostatic pressure sensing means which can delay or time said movement of said second movable surfaces on each compression expansion stroke to maximize the energy capture of said containers, said control means including a means to delay, hold, or lock said pumping or said drive means until the optimum time to allow the most efficient said compression or said expansion stroke of said containers.

5. The device of claim 1 wherein said electrical drive means is a linear generator with either coils or magnets connected to said first fixed surface and the other connected to said second moving surface.

6. The device of claim 1 wherein separate sections of one or more overlapping linearly sliding or telescoping tubes, columns, or beams or one or more interlocking rails are rigidly affixed to the interior or exterior of said fixed first surfaces and said second surfaces in such manner as to freely allow axial said movement between said first and second surface while limiting or eliminating lateral, transverse or shear loads on said flexible third surfaces and on said hydraulic or pneumatic pumping means or said mechanical or electrical drive means within said containers.

7. The device of claim 1 wherein said hydraulic or pneumatic pumping means have multiple or telescoping or staged pumping units of successively engaged increasing cross sectional area as said containers are compressed, in such manner as to achieve or maintain relatively high and constant fluid pumping pressures whether said movement or distance or stroke is small as induced by small said waves and troughs or large as induced by large said waves and troughs.

8. The device of claim 1 wherein one end of a leveraged connecting means such as a scissor or lift table type jack is connected to said container's said second movable surface, said jack's other end being connected to said fixed first surface and to said hydraulic or pneumatic pumping means or said mechanical or electrical drive means in such mechanically leveraged manner that said pump or drive stroke is reduced while the pump or drive force is increased, the intermediate joints of said scissor jack being optionally connected to one or more of the interior flexible joints or pleats or said rings or slats, or reinforcements of said flexible third surface thus laterally stabilizing said flexible surface.

9. The device of claim 1 wherein said anchoring or mooring or depth and location fixing means is the water body sea bed or a rigid pole, mast, spar or column attached to said fixed first surface, said pole, mast, spar or column attached to said sea bed or to ropes or cables attached to said sea bed said masts or spars being optionally laterally stabilized via a plurality of guy wires or cables attached to multiple points of said sea bed and said masts or spars optionally extendable or retractable to adjust the depth of said fixed surface for tides or sea states.

10. The device of claim 1 wherein said anchoring means comprises one or more ropes or cables affixed to the sea bed and said fixed first surface or a rigid pole, mast, spar or column affixed to said first surface and extending downward toward said sea bed, and optionally also one or more buoyancy tanks, floatation collars or one or more stabilization planes affixed to said first fixed surface or said downward pole, mast, spar or column to supplement said container's buoyancy and improve vertical stabilization of said fixed surface, said tanks or collars optionally also serving as said expansion tanks for said containers' gas or said accumulators for said pressurized working fluid from said pumping means, said anchoring means being optionally extendable or retractable to adjust the depth of said first fixed surface for tides or sea states.

11. The device of claim 1 wherein said container(s) are of elongated horizontal section, having a width substantially exceeding said containers depth, said elongated containers having their major axis along said width generally maintained parallel to prevailing wave fronts either by multiple anchoring points or wave induced hydrodynamic orientation means such as vertical or trailing fins.

12. The device of claim 1 wherein more than one of said containers are affixed to a common fixed said first surface or common frame or common said anchoring means.

13. The device of claim 1 wherein said compression or expansion and thereby said stroke or energy capture of said container(s) is enhanced or increased by tension or compression of attachment means from said second moving surface to one or more overhead surface floats or any overhead surface floating wave energy converters or said surface vent buoys or said floating surface expandable bellows or bladders such that when said wave or trough passes over said submerged device, said attachment means moves said second moving surfaces supplementing said increased or decreased hydrostatic pressure which is concurrently compressing and expanding said container while raising or lowering said second moving surface, said attachment means optionally also being said container gas communication means or ducts between said surface vent buoys or said floating surface expandable bellows or bladders and said containers.

14. The device of claim 1 wherein said submerged container(s) also serve as said pneumatic pumping means driving an air turbine generator with said containers' gas flowing in both directions through ducts between said container(s) and said surface vent buoys or said floating surface expandable bellows or bladders.

15. The device of claim 14 wherein said submerged container(s) and said return means also serve as said pneumatic pumping means driving an air turbine generator with said container gas flowing in both directions through ducts between said container(s) and said surface vents or said floating surface expandable bellows or bladder(s).

16. The device of claim 13 wherein expansion of said floating surface vent buoys or floating surface bellows or bladder or springs compressing said bellows or bladders also serves as part of said second movable surface return means.

17. The device of claim 1 wherein said flexible third surface or said flexible bellows or said reinforcing rings also serve as a spring providing part of or the entire said return means.
